(19) United States
(12) Patent Application Publication
(10) Pub. No.: US 2024/0377996 A1
(43) Pub. Date: Nov. 14, 2024

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Yuki SHIMIZU, Kanagawa (JP)

(73) Assignee: FUJIFILM Business Innovation Corp., Tokyo (JP)

(21) Appl. No.: 18/505,339

(22) Filed: Nov. 9, 2023

(30) Foreign Application Priority Data
May 8, 2023 (JP) 2023-076810

(51) Int. Cl. G06F 3/12

(52) U.S. Cl. CPC G06F 3/1205; G06F 3/1245; G06F 3/1267; G06F 3/1274; G06F 3/1288

(57) ABSTRACT

An information processing system includes a processor configured: to accept a print request including print information to be printed and execute one or more predetermined specific processes on the print information included in the accepted print request; and transmit the print request including the print information after execution of the one or more specific processes to a preregistered information processing terminal that is to transmit the print request to a printer.

### CROSS-REFERENCE TO RELATED APPLICATIONS

This application is based on and claims priority under 35 USC 119 from Japanese Patent Application No. 2023-076810 filed May 8, 2023.

### BACKGROUND

### (i) Technical Field

The present disclosure relates to an information processing system, an information processing method, and a non-transitory computer readable medium.

### (ii) Related Art

Japanese Unexamined Patent Application Publication No. 2022-150559 proposes a program causing a computer of an information processing device to function as: acquiring means for acquiring print settings information for a first print instruction in a first format transmitted from the information processing device to a printer without going through a server system; and editing mean s for editing the acquired print settings information. The program transmits a second print instruction including the edited print settings information to the server system.

Japanese Unexamined Patent Application Publication No. 2013-522774 proposes a print server comprising an application manager, format converting means, and a print job router. The application manager is configured to receive a print request over a network from an application executed on a device, and is configured to provide a print dialog over the network to a user of the application, the print dialog providing a selection of at least one printer related to a user account of the user. The application manager is configured to receive a selected printer from the selection. The format converting means is configured to receive a print job designating the selected printer, the print job including print data and print properties expressed in a first format. The format converting means is configured to convert the print job from the first format to a printer-specific format associated with the selected printer. The print job router is configured to use the printer-specific format to route the print job over the network from the print server to a print client associated with the selected printer so that the print job will be printed by the selected printer.

### SUMMARY

When printing with a printer which is not connected to an information processing system, or which is connected but not approved, specific processes provided by the information processing system, such as history management, an authorization process, and a confidentiality process, may no longer be available.

Aspects of non-limiting embodiments of the present disclosure relate to an information processing system, an information processing method, and a non-transitory computer readable medium with which specific process provided by the information processing system are available for use even when printing with a printer which is not connected to the information processing system, or which is connected but not approved.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing system including a processor configured: to accept a print request including print information to be printed and execute one or more predetermined specific processes on the print information included in the accepted print request; and transmit the print request including the print information after execution of the one or more specific processes to a preregistered information processing terminal that is to transmit the print request to a printer.

### BRIEF DESCRIPTION OF THE DRAWINGS

An exemplary embodiment of the present disclosure will be described in detail based on the following figure, wherein:

FIG. 1 is a diagram illustrating a schematic configuration of an information processing system according to an exemplary embodiment;

FIG. 2 is a block diagram illustrating a schematic configuration of an electrical system of an image forming device in the information processing system according to the exemplary embodiment;

FIG. 3 is a block diagram illustrating a schematic configuration of an electrical system of a cloud server, a client computer, and a mobile terminal in the information processing system according to the exemplary embodiment;

FIG. 4 is a diagram illustrating an overview of processes performed by the information processing system according to the exemplary embodiment;

FIG. 5 is a diagram for explaining a flow from the registration to the start of use of a mobile terminal in a print management system;

FIG. 6 is a diagram illustrating an example of a registration screen when registering a mobile terminal in the print management system;

FIG. 7 is a diagram for explaining the registration of a print job in the print management system;

FIG. 8 is a diagram illustrating an example of a print settings screen when setting the mobile terminal to spool to from a print tool of a client computer;

FIG. 9 is a diagram for explaining an example of the flow up to when a print job registered in the print management system is spooled to a mobile terminal;

FIG. 10 is a diagram illustrating an example of screens displayed on a mobile terminal during spooling and after spooling is completed;

FIG. 11 is a diagram for explaining the flow up to when a print job spooled to a mobile terminal is transmitted to an image forming device;

FIG. 12 is a diagram illustrating an example of a spooled print job list screen;

FIG. 13 is a flowchart illustrating an example of a flow of processes performed by a client computer when a print job is transmitted from the client computer to the print management system in the information processing system according to the exemplary embodiment;

FIG. 14 is a flowchart illustrating an example of a flow of processes performed by a cloud server when the print management system receives a print job in the information processing system according to the exemplary embodiment;

FIG. 15 is a flowchart illustrating an example of a flow of processes performed by a mobile terminal when print jobs are spooled in the information processing system according to the exemplary embodiment;

FIG. 16 is a flowchart illustrating an example of a flow of processes performed by a mobile terminal when a completely spooled print job is transmitted from a mobile terminal to an image forming device in the information processing system according to the exemplary embodiment; and

FIG. 17 is a flowchart illustrating an example of a flow of processes performed by a mobile terminal when a print job that has been spooled to the mobile terminal is removed in the information processing system according to the exemplary embodiment.

### DETAILED DESCRIPTION

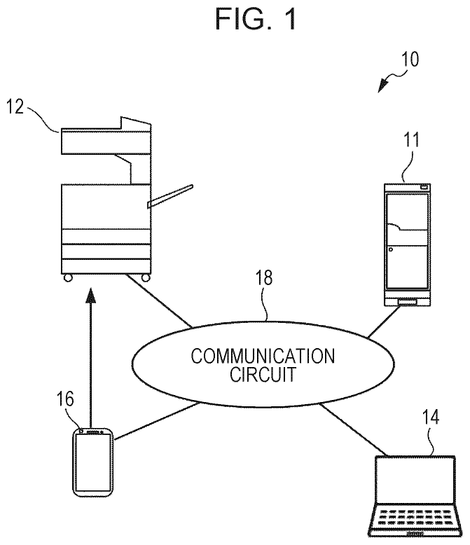

Hereinafter, an exemplary embodiment of the present disclosure will be described in detail and with reference to the drawings. As an example, the exemplary embodiment describes an information processing system in which a cloud server 11, an image forming device, a client computer, and a mobile terminal or the like are interconnected through a communication circuit, such as any of various types of networks. FIG. 1 is a diagram illustrating a schematic configuration of an information processing system 10 according to the exemplary embodiment.

As illustrated in FIG. 1, the information processing system 10 according to the exemplary embodiment includes a cloud server 11, an image forming device 12 as one example of a printer, a client computer 14, and a mobile terminal 16 as one example of an information processing terminal. The cloud server 11, the image forming device 12, and the client computer 14 are interconnected via a communication circuit 18 such as a local area network (LAN), a wide area network (WAN), the Internet, or an intranet. Additionally, each of the cloud server 11, the image forming device 12, the client computer 14, and the mobile terminal 16 is capable of bidirectionally transmitting and receiving various data through the communication circuit 18. In the exemplary embodiment, an image is formed in accordance with a print instruction in the image forming device 12 by instructing the image forming device 12 to print from the client computer 14 or the mobile terminal 16 via the cloud server 11.

Note that although FIG. 1 illustrates one of each of the cloud server 11, the image forming device 12, the client computer 14, and the mobile terminal 16, each of the above may be multiple devices, or any of the above may be multiple devices. In the information processing system 10 according to the exemplary embodiment, a print instruction may be issued from the mobile terminal 16 through the communication circuit 18, but a print instruction may also be issued from the mobile terminal 16 via short-range wireless communication such as Wi-Fi® or Bluetooth®. The mobile terminal 16 may be a mobile phone such as a smartphone, a personal digital assistant (PDA), or a laptop personal computer, for example.

The image forming device 12 according to the exemplary embodiment has multiple functions, such as: an image forming function that performs an image forming process; a reading function that reads a document to obtain image information representing the document; a copy function that copies an image recorded on a document onto paper; a facsimile function that transmits and receives various data through a telephone circuit not illustrated; a forwarding function that forwards document information such as image information read by the reading function or the like; and a storage function that stores document information such as read image information. The multiple functions may be all of the above functions, or any two or more of the above functions.

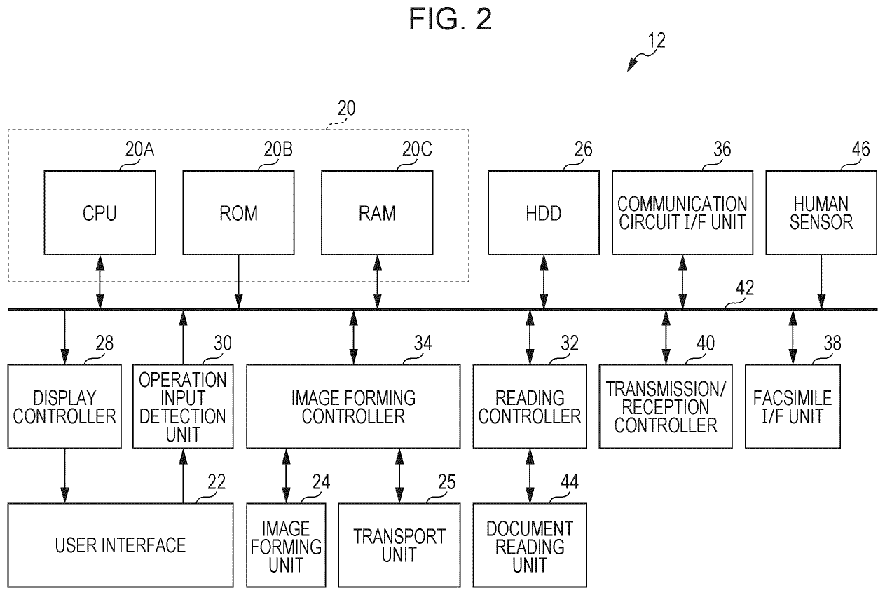

FIG. 2 is a block diagram illustrating a schematic configuration of an electrical system of the image forming device 12 in the information processing system 10 according to the exemplary embodiment.

As illustrated in FIG. 2, the image forming device 12 according to the exemplary embodiment is provided with a control unit 20 including a central processing unit (CPU) 20A, read-only memory (ROM) 20B, and random access memory (RAM) 20C. The CPU 20A administers the overall operation of the image forming device 12. The RAM 20C is used as a work area or the like when the CPU 20A executes various programs. Various information processing programs such as application programs, various parameters, and the like are stored in advance in the ROM 20B. In the image forming device 12, the components of the control unit 20 are electrically connected by a system bus 42.

On the other hand, the image forming device 12 according to the exemplary embodiment is provided with a hard disk drive (HDD) 26 that stores various data, application programs, and the like. The image forming device 12 is provided with a display controller 28 which is connected to a user interface 22 and which controls the display of various operating screens and the like on a display of the user interface 22. The image forming device 12 is also provided with an operation input detection unit 30 which is connected to the user interface 22 and which detects operation instructions inputted through the user interface 22. In the image forming device 12, the HDD 26, the display controller 28, and the operation input detection unit 30 are electrically connected to the system bus 42. Note that although the HDD 26 is implemented as a memory in the image forming device 12 according to the exemplary embodiment, the configuration is not limited thereto, and non-volatile memory such as flash memory may also be implemented. Moreover, in the exemplary embodiment, a touch panel capable of displaying information and accepting operation input is implemented as the user interface 22, but the configuration is not limited thereto, and a user interface with a display and an operation unit that are separate may also be implemented.

The image forming device 12 according to the exemplary embodiment is provided with a reading controller 32 that controls an operation of reading an optical image with a document reading unit 44 and an operation of feeding a document with a document transport unit, and an image forming controller 34 that controls an image forming process by an image forming unit 24 and the transport of paper to the image forming unit 24 by a transport unit 25. The image forming device 12 is also provided with a communication circuit interface (I/F) unit 36 which is connected to the communication circuit 18 and which transmits and receives communication data with another external device such as the client computer 14 connected to the communication circuit 18. The image forming device 12 is also provided with a facsimile interface (I/F) unit 38 which is connected to a telephone circuit not illustrated and which transmits and receives facsimile data with a facsimile device connected to the telephone circuit. The image forming device 12 is also provided with a transmission/reception controller 40 that controls the transmission and reception of facsimile data through the facsimile I/F unit 38. The image forming device 12 is also provided with a human sensor 46 that detects a person near the device. Additionally, in the image forming device 12, the transmission/reception controller 40, the reading controller 32, the image forming controller 34, the communication circuit I/F unit 36, the facsimile I/F unit 38, and the human sensor 46 are electrically connected to the system bus 42.

According to the above configuration, in the image forming device 12 according to the exemplary embodiment, access to each of the RAM 20C, the ROM 20B, and the HDD 26 is executed by the CPU 20A. In the image forming device 12, control of the display of operating screens and information such as various messages on a display of the user interface 22 through the display controller 28 is executed by the CPU 20A. In the image forming device 12, control of the workings of the document reading unit 44 and the document transport unit through the reading controller 32 is executed by the CPU 20A. In the image forming device 12, control of the workings of the image forming unit 24 and the transport unit 25 through the image forming controller 34 and control of the transmission and reception of communication data through the communication circuit I/F unit 36 are executed by the CPU 20A. In the image forming device 12, control of the transmission and reception of facsimile data through the facsimile I/F unit 38 by the transmission/reception controller 40 is executed by the CPU 20A. Furthermore, in the image forming device 12, the CPU 20A ascertains operation content in the user interface 22 based on operation information detected by the operation input detection unit 30, and executes various types of control based on the operation content.

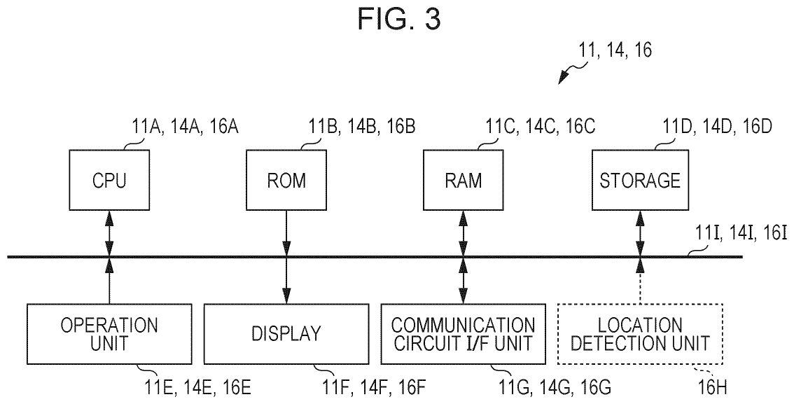

Next, a schematic configuration of the electrical system of the cloud server 11, the client computer 14, and the mobile terminal 16 according to the exemplary embodiment will be described. FIG. 3 is a block diagram illustrating a schematic configuration of the electrical system of the cloud server 11, the client computer 14, and the mobile terminal 16 in the information processing system 10 according to the exemplary embodiment. Note that since the cloud server 11, the client computer 14, and the mobile terminal 16 all have a typical computer configuration, the following describes the cloud server 11 as a representative example.

As illustrated in FIG. 3, the cloud server 11 according to the exemplary embodiment is provided with a CPU 11A as one example of a processor, ROM 11B, RAM 11C, storage 11D, an operation unit 11E, a display 11F, and a communication circuit interface (I/F) unit 11G. The CPU 11A administers the overall operation of the cloud server 11. Information such as various control programs and various parameters is stored in advance in the ROM 11B. The RAM 11C is used as a work area or the like when the CPU 11A executes various programs. Various data, application programs, and the like are stored in the storage 11D. The operation unit 11E is used to input various information. The display 11F is used to display various information. The communication circuit I/F unit 11G is connected to the communication circuit 18, and transmits and receives various data with other devices connected to the communication circuit 18. The communication circuit I/F unit 11G may also be configured to communicate with equipment directly using any of various known types of wireless communication. The above components of the cloud server 11 are electrically interconnected by a system bus 11I. Note that although the storage 11D is implemented as a memory in the cloud server 11 according to the exemplary embodiment, examples of implementable storage also include a hard disk drive (HDD) and non-volatile memory such as flash memory.

According to the above configuration, in the cloud server 11 according to the exemplary embodiment, access to the ROM 11B, the RAM 11C, and the storage 11D, the acquisition of various data through the operation unit 11E, and the display of various information on the display 11F are executed by the CPU 11A. In the cloud server 11, control of the transmission and reception of communication data through the communication circuit I/F unit 11G is executed by the CPU 11A.

Note that the mobile terminal 16 may include components which are not present in the cloud server 11, such as a location detection unit 16H that detects the location of the mobile terminal 16 using the Global Positioning System (GPS) or the like, and a camera or other image capture unit (not illustrated).

In the information processing system 10 according to the exemplary embodiment configured in this way, the cloud server 11 provides a print management system as a cloud service that performs predetermined specific processes on print jobs to be printed by the image forming device 12. Examples of the specific processes include a history management process that manages a history of print jobs, an authorization process that authorizes print jobs, and a confidentiality process that masks confidential portions of print jobs or the like. For example, in the print management system, the cloud server 11 accepts a print job from the client computer 14, performs an authorization process on the accepted print job, and transmits the authorized print job to the image forming device 12. With this arrangement, only authorized print jobs are printed by the image forming device 12. Note that a print job refers to a process or set or processes to be executed by the image forming device 12 in order to execute printing.

However, when printing with an image forming device 12 which is not connected to the information processing system 10, or which is connected but not approved, specific processes provided by the information processing system 10 may no longer be available.

Accordingly, the information processing system 10 according to the exemplary embodiment accepts a print job as a print request including print information to be printed, executes predetermined specific processes on the print information included in the accepted print job, and transmits the print job to the mobile terminal 16 as a preregistered information processing terminal that is to transmit the print job including the print information after execution of the specific processes to the image forming device 12.

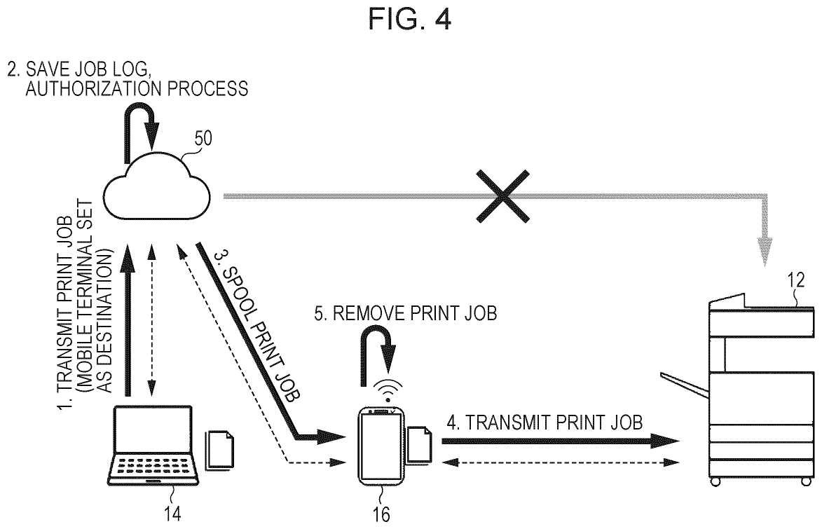

Specifically, as illustrated in FIG. 4, a print job from the client computer 14 is addressed to the mobile terminal 16 and transmitted to a print management system 50 in the cloud. Note that FIG. 4 is a diagram illustrating an overview of processes performed by the information processing system 10 according to the exemplary embodiment.

Upon accepting a print job, the print management system 50 saves a job log for managing a history and performs an authorization process for authorizing printing as the specific processes. Note that the authorization process involves, for example, sending a request to authorize printing of the print job to a preregistered client computer 14 and receiving an authorization result. Specifically, an authorization request email is transmitted to the email address of a preregistered authorizer. The authorizer operates the client computer 14 to open the email, launch a web browser from a link in the email, log in to the information processing system, confirm the print job to be authorized, and perform an authorization operation. On the basis of the authorization operation, the information processing system authorizes the print job to be authorized.

Next, the print management system 50 transmits the print job after the specific processes to the recipient mobile terminal 16 designated by the client computer 14 to spool the print job to the mobile terminal 16. Note that spooling means temporarily storing print information in a separate location rather than transmitting the print information directly to the image forming device 12.

Thereafter, short-range wireless communication is used to transmit the print job from the mobile terminal 16 to the image forming device 12, thereby causing the print job after the specific processes to be printed by the image forming device 12. This arrangement enables printing to be performed using specific processes provided by the information processing system 10, even when printing with an image forming device 12 which is not connected to the information processing system, or which is connected but not approved. Note that in the exemplary embodiment, the print job is described as being transmitted from the mobile terminal 16 to the image forming device 12 by short-range wireless communication, but configuration is not limited to short-range wireless communication, and the print job may also be transmitted through a connection to the communication circuit 18 or by a wired connection.

A method of spooling a print job to the mobile terminal 16 and printing with the image forming device 12 will be described specifically.

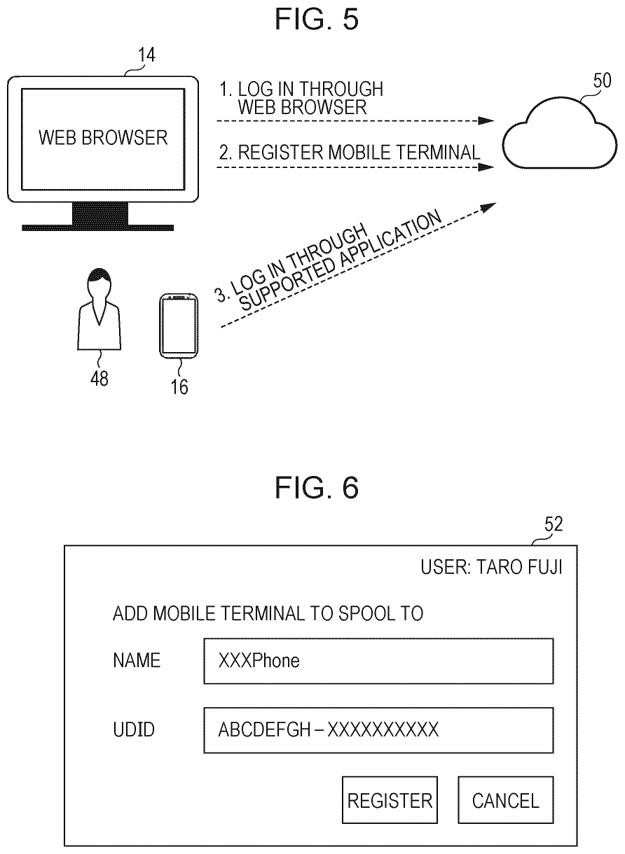

First, the flow from the registration to the start of use of the mobile terminal 16 in the print management system 50 will be described. FIG. 5 is a diagram for explaining a flow from the registration to the start of use of the mobile terminal 16 in the print management system 50.

A user logs in to the print management system 50 in the cloud through a web browser from the client computer 14 or the mobile terminal 16 of a user 48, and registers the mobile terminal 16 of the user 48.

Registration involves registering information that can be used to uniquely identify the mobile terminal 16. For example, information such as a unique device identifier (UDID), a serial number, an International Mobile Equipment Identity (IMEI) number, or a media access control (MAC) address is registered.

A supported application is installed on the mobile terminal to log in to the system. This arrangement allows for print jobs to be spooled to the mobile terminal.

When registering the mobile terminal 16 of the user 48, the registration screen 52 illustrated in FIG. 6 is displayed in a web browser to accept the registration of the mobile terminal 16, for example. FIG. 6 is a diagram illustrating an example of the registration screen 52 when registering the mobile terminal 16 in the print management system 50. Note that the mobile terminal 16 is registered from the client computer 14 or from the mobile terminal 16.

The registration screen 52 in FIG. 6 illustrates an example in which “XXXPhone” is inputted as the name of the mobile terminal and “ABCDEFGH-XXXXXXXXXX” is inputted as the UDID. By operating “Register” in FIG. 6, the mobile terminal 16 is registered in the print management system 50. On the other hand, by operating “Cancel” in FIG. 6, the registration of the mobile terminal 16 is canceled.

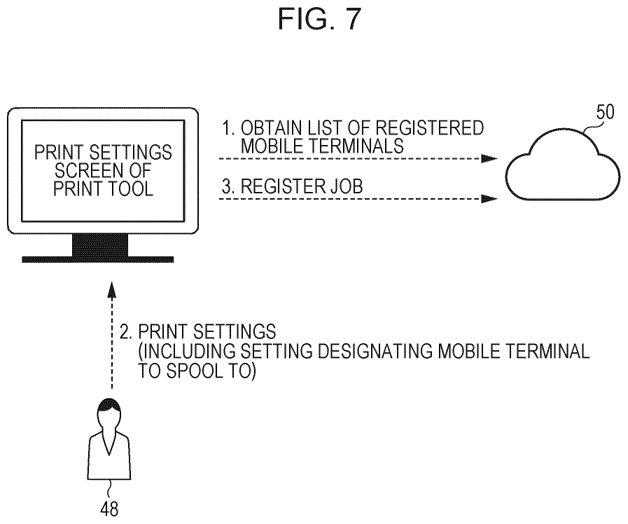

Next, the registration of a print job in the print management system 50 will be described. FIG. 7 is a diagram for explaining the registration of a print job in the print management system 50.

A print job is registered using a print tool such as a printer driver that supports cloud printing or a web user interface (UI).

Specifically, when displaying a print settings screen of the print tool such as a printer driver or a web UI, a list of mobile terminals 16 to spool to, which are associated with the user 48 who is logged in to the print management system 50, is acquired by downloading from the print management system 50.

The user 48 sets the mobile terminal 16 to spool to from the list of mobile terminals 16 and registers the print job. The setting of the mobile terminal 16 to spool to is assumed to allow the selection of all mobile terminals 16 carried by the user 48, or a mobile terminal 16 designated by the user 48.

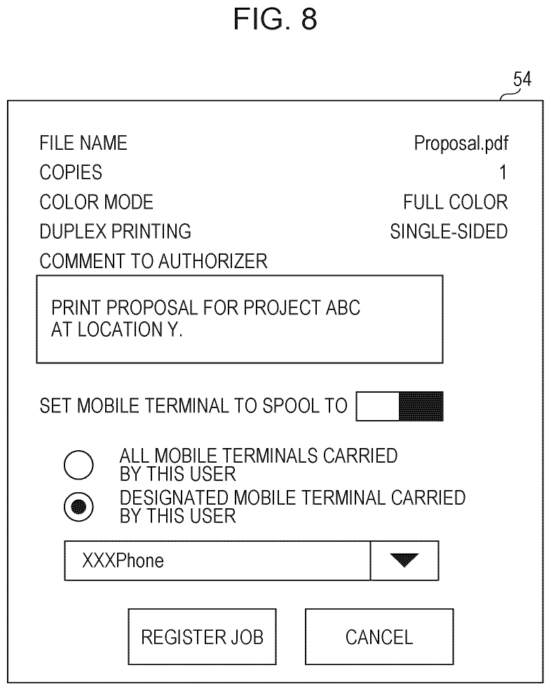

FIG. 8 is a diagram illustrating an example of a print settings screen 54 when setting the mobile terminal 16 to spool to from the print tool of the client computer 14.

The print settings screen 54 in FIG. 8 illustrates an example of print settings in which the file name is set to “Proposal.pdf”, the number of copies is set to “1”, the color mode is set to “full color”, and duplex printing is set to “single-sided”. Also, the print settings screen 54 in FIG. 8 illustrates an example in which “Print proposal for Project ABC at Location Y” has been inputted as a comment to the authorizer. Furthermore, the print settings screen 54 in FIG. 8 illustrates an example in which “Set mobile terminal to spool to” is enabled, “Designated mobile terminal carried by this user” is selected, and “XXXPhone” is selected as the mobile terminal 16. By operating “Register Job” in FIG. 8, the print job is registered in the print management system 50. On the other hand, by operating “Cancel”, the registration of the print job is canceled.

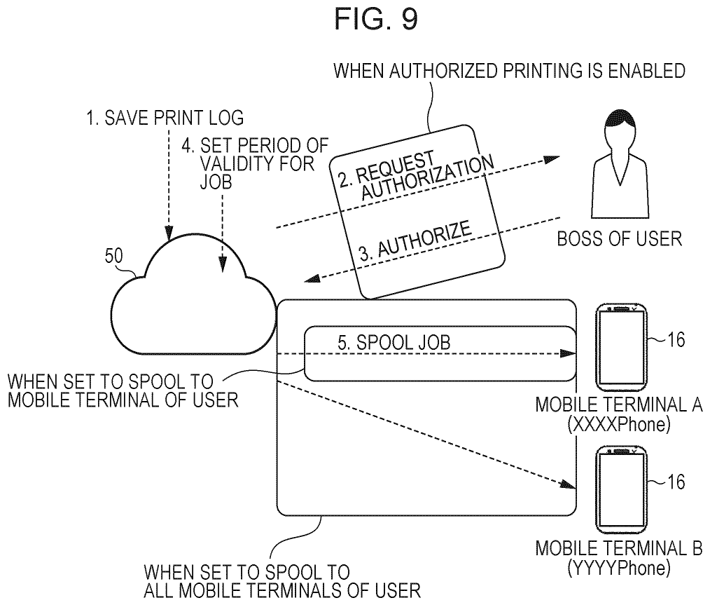

The following describes the flow up to when a print job registered in the print management system 50 is spooled to the mobile terminal 16. FIG. 9 is a diagram for explaining an example of the flow up to when a print job registered in the print management system 50 is spooled to the mobile terminal 16. Note that the following describes an example of performing a history management process, an authorization process, and a process of setting a period of validity as the specific processes.

When a print job is registered in the print management system 50, a job log is saved in the print management system 50 in the cloud, print authorization is performed to make an authorization request and obtain authorization, and a period of validity is set for the print job, after which the print job is spooled to the mobile terminal 16. Specifically, as illustrated in FIG. 9, the print management system 50 saves a job log and performs the authorization process if authorized printing is enabled. In other words, the print management system 50 transmits an authorization request to the client computer 14 used by the boss of the user 48, and receives an authorization result regarding the print job. If an authorization result is received and the print job is authorized, the print management system 50 sets a period of validity for the job. The setting of the period of validity involves setting a predetermined deadline, for example. The predetermined deadline may be set by setting a period of authorized printing, a default period, or the like in advance, and setting the period of validity by deriving a deadline from the preset period.

After all of the process are completed, the print job is spooled to the mobile terminal 16 set as the spool target when the job was registered. FIG. 9 illustrates an example of spooling to a mobile terminal A (XXXXPhone) as the case of transmitting the print job to a designated mobile terminal 16 carried by the user 48, and spooling to the mobile terminal A (XXXXPhone) and a mobile terminal B (YYYYPhone) as the case of transmitting the print job to all mobile terminals 16 carried by the user 48.

The configuration of a spooled print job includes “print information” and “attribute information of the print information”, and this information is collectively referred to as the “print job”. Attribute information refers to print settings information managed separately from the print information, and information that includes the period of validity of the print job.

Spooling a print job normally involves transmitting from the cloud via push notification, but a print job may also be received via pull notification at any time chosen by the user 48.

In a situation of printing from the mobile terminal 16 at another location or a visited destination, the output destination may not have the image forming device 12 of one's own company, and therefore the print job is spooled to the mobile terminal 16 after converting the format of the print job to a predetermined common format to allow the print job to be outputted irrespectively of the type of image forming device 12. The print job is spooled to the mobile terminal 16 after converting the format to any of various common formats offered by various companies, such as the Portable Document Format (pdf) or Mopria.

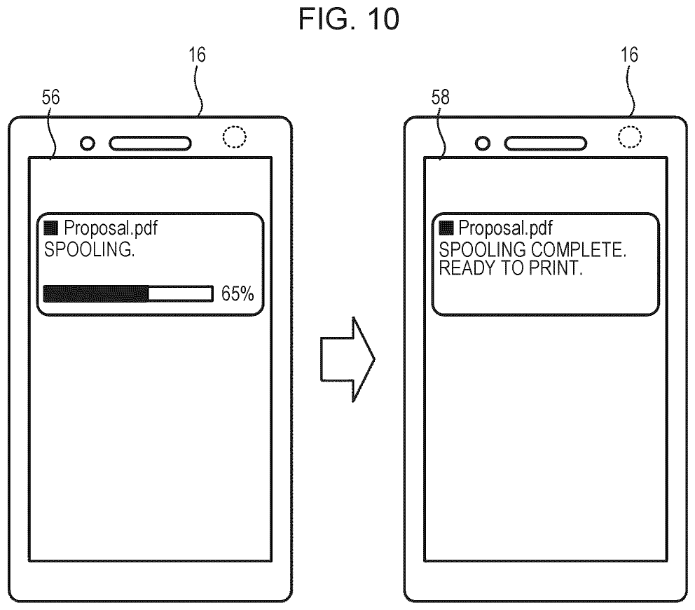

FIG. 10 is a diagram illustrating an example of a progress screen 56 displayed on the mobile terminal 16 during spooling and a spooling complete screen 58 displayed after spooling is completed.

When spooling a print job to the mobile terminal 16, the progress of spooling is displayed on a screen like the progress screen 56 illustrated in FIG. 10. The progress screen 56 in FIG. 10 illustrates an example in which “Proposal.pdf” is being spooled, and the spooling is 65% complete. When spooling is completed, the spooling complete screen 58 is displayed. The spooling complete screen 58 in FIG. 10 illustrates an example in which “Proposal.pdf” has completed spooling and is ready to print.

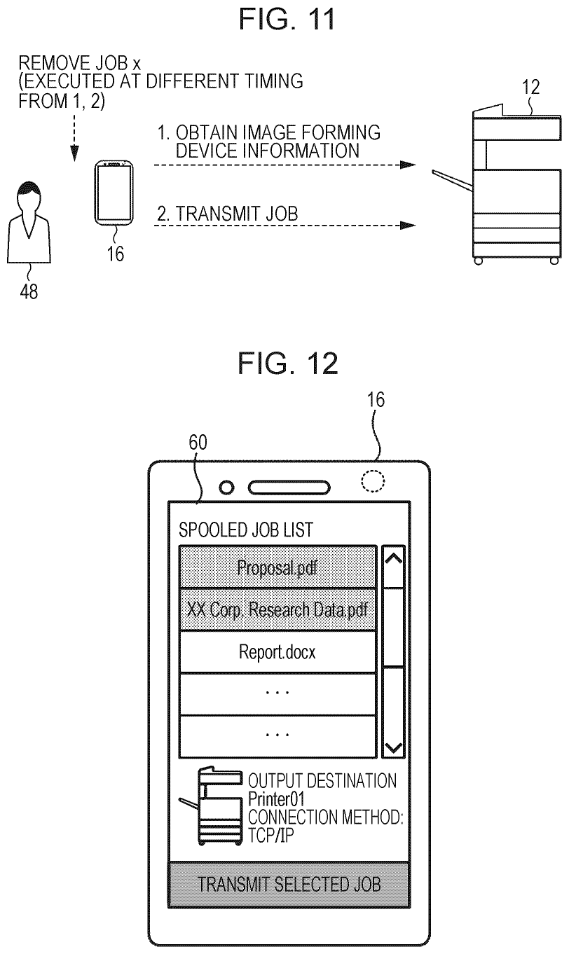

The following describes the flow up to when a print job spooled to the mobile terminal 16 is transmitted to the image forming device 12. FIG. 11 is a diagram for explaining the flow up to when a print job spooled to the mobile terminal 16 is transmitted to the image forming device 12.

The supported application is launched on the mobile terminal 16, and as illustrated in FIG. 11, the Internet Protocol (IP) address of the image forming device 12 to connect to is acquired and set, and the job is transmitted to the image forming device 12.

Information for connecting to the image forming device 12 may be set through manual input by the user 48, or may be set by reading a near field communication (NFC) tag or a Quick Response (QR) code installed with respect to the image forming device 12.

Transmission of a print job is executed according to an operation by the user 48. For example, as illustrated in FIG. 12, the supported application on the mobile terminal 16 displays a spooled print job list screen 60, and the user 48 selects a desired print job to print and presses a Transmit button to transmit the selected print job. FIG. 12 is a diagram illustrating an example of the spooled print job list screen 60. FIG. 12 illustrates an example in which two jobs for “Proposal.pdf” and “XX Corp. Research Data.pdf” are selected from the job list, whereas other jobs for “Report.docx” and the like are unselected.

The supported application on the mobile terminal 16 periodically checks the period of validity from the attribute information of spooled print jobs, and removes a job upon detecting that the period of validity has expired, irrespectively of whether the job has been transmitted to the image forming device 12.

The following describes detailed processes performed by each device of the information processing system 10 according to the exemplary embodiment configured as above.

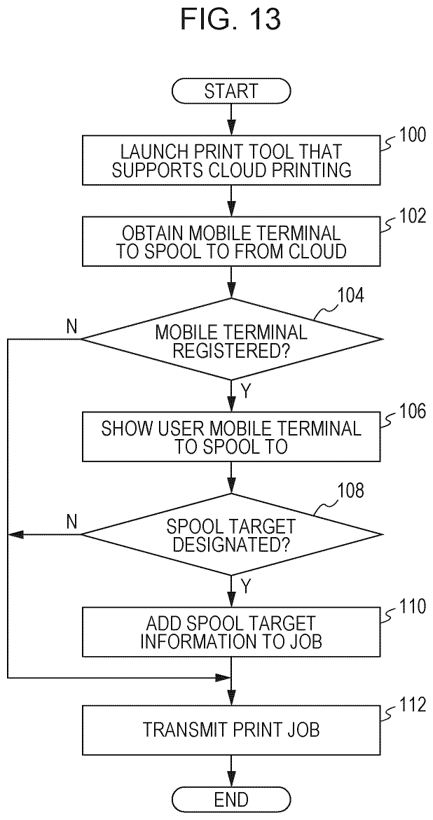

First, processes performed by the client computer 14 when transmitting a print job from the client computer 14 to the print management system 50 will be described. FIG. 13 is a flowchart illustrating an example of a flow of processes performed by the client computer 14 when a print job is transmitted from the client computer 14 to the print management system 50 in the information processing system 10 according to the exemplary embodiment. Note that the processes in FIG. 13 are started when, for example, the user 48 operates the client computer 14 and the print tool is launched.

In step 100, the CPU 14A launches the print tool that supports cloud printing, and proceeds to step 102. In other words, a print tool such as a printer driver is launched.

In step 102, the CPU 14A acquires the mobile terminal 16 to spool to from the cloud, and proceeds to step 104. In other words, a list of mobile terminals 16 to spool to, which are associated with the user 48 who is logged in to the print management system 50, is acquired by downloading from the print management system 50.

In step 104, the CPU 14A determines whether there is a registered mobile terminal 16 to spool to. If the determination is positive, the CPU 14A proceeds to step 106, whereas if negative, the CPU 14A proceeds to step 112.

In step 106, the CPU 14A shows the user 48 the mobile terminal 16 to spool to, and proceeds to step 108. In other words, the list of mobile terminals 16 acquired from the print management system 50 is displayed on the display 14F.

In step 108, the CPU 14A determines whether a spool target is designated. This determination involves determining whether “Set mobile terminal to spool to” is enabled on the print settings screen 54 in FIG. 8, for example. If the determination is positive, the CPU 14A proceeds to step 110, whereas if negative, the CPU 14A proceeds to step 112.

In step 110, the CPU 14A adds spool target information to the print job, and proceeds to step 112.

In step 112, the CPU 14A transmits the print job to the print management system 50, and ends the series of processes.

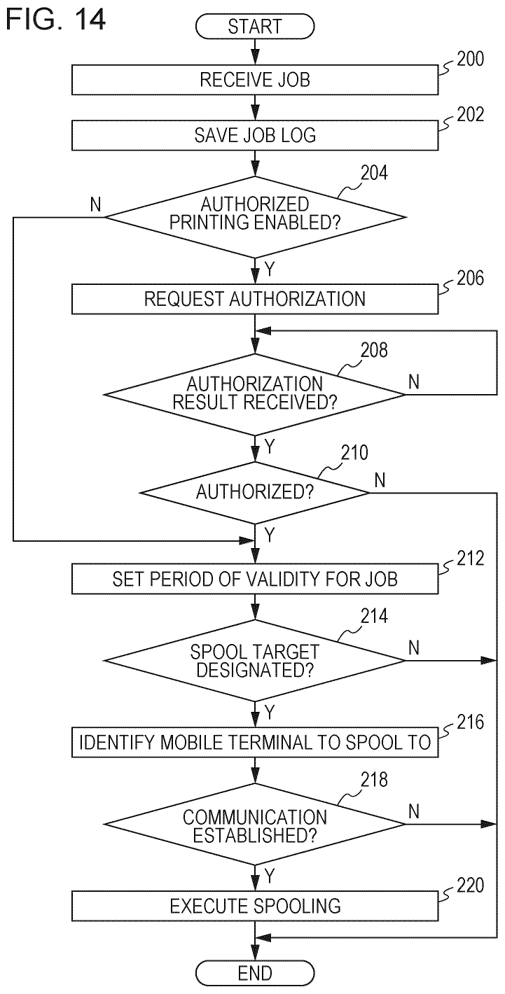

The following describes processes when the print management system 50 in the cloud receives a print job. FIG. 14 is a flowchart illustrating an example of a flow of processes performed by the cloud server 11 when the print management system 50 receives a print job in the information processing system 10 according to the exemplary embodiment. Note that the processes in FIG. 14 are started when a print job is transmitted from the client computer 14.

In step 200, the CPU 11A receives a print job and proceeds to step 202. In other words, the CPU 11A receives the print job that was transmitted from the client computer 14 in step 112 above.

In step 202, the CPU 11A saves a job log and proceeds to step 204. In other words, as a specific process, a history of jobs is saved as a job log.

In step 204, the CPU 11A determines whether authorized printing is enabled. The determination may involve determining whether authorized printing is set in the print job or determining whether authorized printing is enabled by a setting in the print management system 50. If the determination is positive, the process proceeds to step 206, whereas if negative, the process proceeds to step 212.

In step 206, the CPU 11A makes an authorization request and proceeds to step 208. For example, the CPU 11A transmits an authorization request to the client computer 14 of a boss or the like registered in advance.

In step 208, the CPU 11A determines whether an authorization result is received. The CPU 11A stands by until the determination is positive, and then proceeds to step 210.

In step 210, the CPU 11A determines whether printing is authorized. If the determination is positive, the process proceeds to step 212, whereas if negative, the series of processes ends.

In step 212, the CPU 11A sets a period of validity for the job, and proceeds to step 214. For example, the CPU 11A sets in the print job a period of validity calculated from a period set in advance by an administrator or the like.

In step 214, the CPU 11A determines whether a spool target exists. This determination involves, for example, determining whether spool target information was added to the print job in step 110 above. If the determination is positive, the process proceeds to step 216, whereas if negative, the series of processes ends.

In step 216, the CPU 11A identifies the mobile terminal 16 to spool to, and proceeds to step 218. In other words, the CPU 11A identifies the mobile terminal 16 to spool to that was set on the print settings screen 54 in FIG. 8.

In step 218, the CPU 11A determines whether communication is established with the mobile terminal 16 to spool to. If the determination is positive, the process proceeds to step 220, whereas if negative, the series of processes ends. Note that when the determination is negative, communication may be reattempted after a predetermined time elapses or the like, and the CPU 11A may determine whether communication has been established. Also, in this case, the series of processes may be ended if communication is not established after a predetermined number of attempts.

In step 220, the CPU 11A starts spooling the print job to the mobile terminal 16, and ends the series of processes.

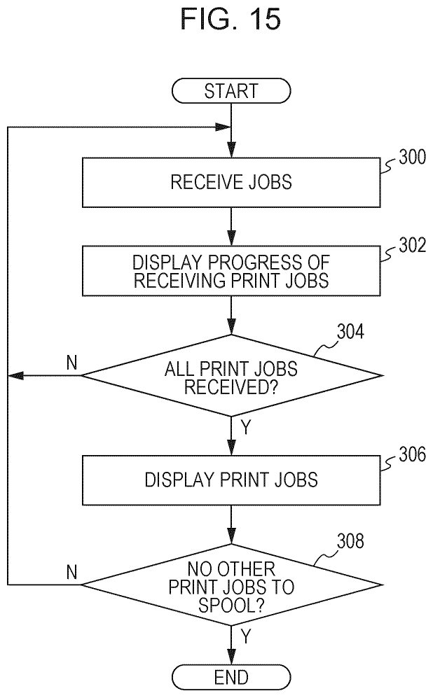

The following describes processes performed by the mobile terminal 16 when print jobs are spooled. FIG. 15 is a flowchart illustrating an example of a flow of processes performed by the mobile terminal 16 when print jobs is spooled in the information processing system 10 according to the exemplary embodiment. Note that the processes in FIG. 15 are started when print jobs to be spooled are transmitted from the print management system 50.

In step 300, the CPU 16A receives print jobs transmitted from the print management system, and proceeds to step 302.

In step 302, the CPU 16A displays the progress of receiving the print jobs on the display 16F, and proceeds to step 304. For example, the CPU 16A displays the spooling progress screen 56 as illustrated in FIG. 10.

In step 304, the CPU 16A determines whether all print jobs have been received. If the determination is positive, the process proceeds to step 306, whereas if negative, the CPU 16A returns to step 300 and repeats the above processes.

In step 306, the CPU 16A displays the print jobs and proceeds to step 308. In other words, the CPU 16A displays the print jobs received from the print management system 50 on the display 16F. For example, the CPU 16A displays the spooled print job list screen 60 on the display 16F as illustrated in FIG. 12.

In step 308, the CPU determines whether there are no other print jobs to spool. If the determination is negative, the CPU returns to step 300 and repeats the processes above, whereas if the determination is positive, the CPU ends the series of processes.

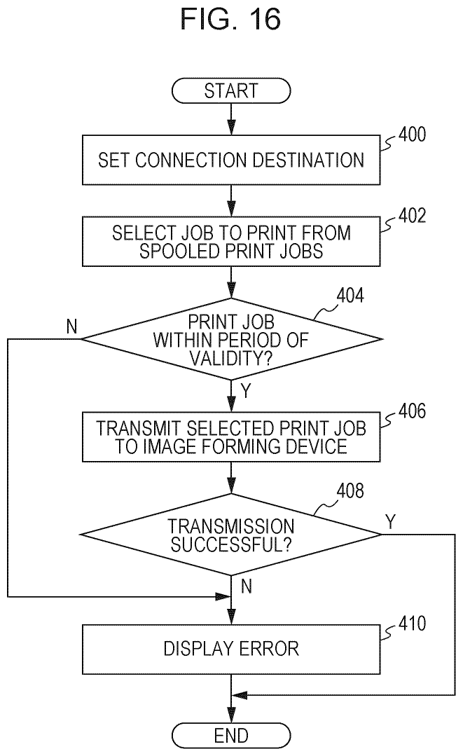

Next, processes performed when transmitting a completely spooled print job from the mobile terminal 16 to the image forming device 12 will be described. FIG. 16 is a flowchart illustrating an example of a flow of processes performed by a mobile terminal when a completely spooled print job is transmitted from the mobile terminal 16 to the image forming device 12 in the information processing system 10 according to the exemplary embodiment. Note that the processes in FIG. 16 are started after a print job is spooled from the print management system 50, when the supported application installed on the mobile terminal 16 is launched and a predetermined operation is performed to start transmitting the print job to the image forming device 12, for example.

In step 400, the CPU 16A sets the connection destination and proceeds to step 402. In other words, the CPU 16A acquires and sets the IP address of the image forming device 12 to connect to.

In step 402, the CPU 16A selects a print job to print from among the spooled print jobs, and proceeds to step 404. For example, as illustrated in FIG. 12, the CPU 16A displays a list of spooled print jobs and accepts the selection of a print job to print.

In step 404, the CPU 16A determines whether the selected print job is within the period of validity. If the determination is positive, the process proceeds to step 406, whereas if negative, the process proceeds to step 410.

In step 406, the CPU 16A transmits the selected print job to the image forming device 12, and proceeds to step 408.

In step 408, the CPU 16A determines whether transmission is successful. If the determination is positive, the CPU 16A ends the series of processes, whereas if negative, the CPU 16A proceeds to step 410. Note that when transmission is successful, the CPU 16A may remove the transmitted print job before ending the processes.

In step 410, the CPU 16A displays an error on the display 16F, and ends the series of processes.

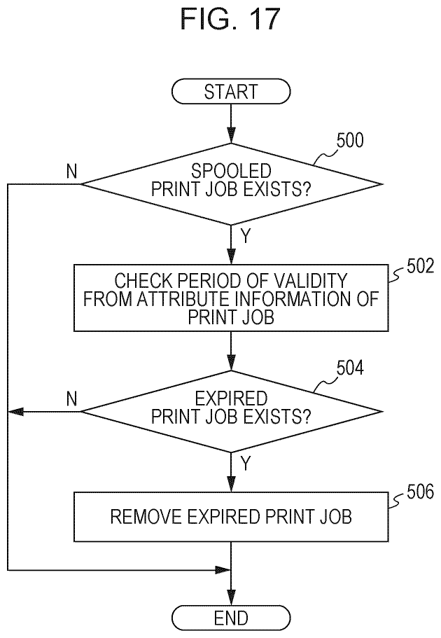

The following describes the flow when removing a print job that has been spooled to the mobile terminal 16. FIG. 17 is a flowchart illustrating an example of a flow of processes performed by the mobile terminal 16 when a print job that has been spooled to the mobile terminal 16 is removed in the information processing system 10 according to the exemplary embodiment. Note that the processes in FIG. 17 are started at, for example, at least one timing from among when the application is launched, when the application moves from the background to the foreground, and when a fixed time elapses (for example, every hour).

In step 500, the CPU 16A determines whether a spooled print job exists. If the determination is positive, the CPU 16A proceeds to step 502, whereas if negative, the CPU 16A ends the series of processes.

In step 502, the CPU 16A checks the period of validity from the attribute information of the print job, and proceeds to step 504.

In step 504, the CPU 16A determines whether an expired print job exists. If the determination is positive, the CPU 16A proceeds to step 506, whereas if negative, the CPU 16A ends the series of processes.

In step 506, the CPU 16A removes the expired print job, and ends the series of processes.

Note that although the exemplary embodiment above describes an example of spooling a print job from the print management system 50 to the mobile terminal 16 and then transmitting the print job to the image forming device 12, information that has been spooled to the mobile terminal 16 may also be transmitted to a destination other than the image forming device 12. For example, in another exemplary embodiment, information to be processed may be registered in the cloud server 11, the registered information to be processed may be spooled to the mobile terminal 16, and the spooled information may be transmitted to another cloud server or to a processing device such as an image processing device.

In the exemplary embodiment, the term “processor” refers to hardware in a broad sense. Examples of the processor include general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The “system” in the exemplary embodiment is described as a configuration formed by multiple devices as an example, but may also be a configuration formed by a single device.

The processes performed by the information processing system 10 according to the exemplary embodiment above may be processes performed by software, processes performed by hardware, or processes performed by a combination of the two. Moreover, the processes performed by the information processing system 10 may be stored and distributed on a storage medium as a program.

The present disclosure is not limited to the foregoing, and obviously various modifications other than the above may be carried out within a scope that does not depart from the gist of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
a processor configured to:
   accept a print request including print information to be printed and execute one or more predetermined specific processes on the print information included in the accepted print request; and
   transmit the print request including the print information after execution of the one or more specific processes to a preregistered information processing terminal that is to transmit the print request to a printer.
      (((2)))

The information processing system according to (((1))), wherein the processor is configured to convert the print request to information in a predetermined common format, and transmit the converted information to the information processing terminal.

(((3)))

The information processing system according to (((1))) or (((2))), wherein the processor is configured to execute at least one from among history management processing, an authorization process, and a confidentiality process as the one or more specific processes.

(((4)))

The information processing system according to any one of (((1))) to (((3))), wherein the processor is configured to display, on the information processing terminal, a progress of transmitting the print request after execution of the one or more specific processes to the information processing terminal.

(((5)))

The information processing system according to any one of (((1))) to (((4))), wherein the processor is configured to set a period of validity for the print request and transmit the print request to the information processing terminal.

(((6)))

The information processing system according to (((5))), wherein the processor is configured to confirm the period of validity at a predetermined timing, and remove the print request that has expired.

(((7)))

The information processing system according to (((6))), wherein the predetermined timing is at least one from among when an application is launched on the information processing terminal, when the application moves from background to foreground, and when a fixed time elapses.

(((8)))

The information processing system according to any one of (((1))) to (((7))), wherein the processor is configured to accept a selection result of the information processing terminal to which to transmit the print request after execution of the one or more specific processes, and transmit the print request to the selected information processing terminal.

(((9)))

The information processing system according to (((8))), wherein the processor is configured to accept the information processing terminal designated by a user or all information processing terminals carried by the user as the selection result.

(((10)))

The information processing system according to any one of (((1))) to (((9))), wherein the processor is configured to transmit the print request that has been transmitted to the information processing terminal to the printer by wireless communication.

(((11)))

An information processing program causing a computer to execute a process comprising:
accepting a print request including print information to be printed and executing one or more predetermined specific processes on the print information included in the accepted print request; and
transmitting the print request including the print information after execution of the specific processes to a preregistered information processing terminal that is to transmit the print request to a printer.

What is claimed is:

1. An information processing system comprising:
a processor configured to:
accept a print request including print information to be printed and execute one or more predetermined specific processes on the print information included in the accepted print request; and
transmit the print request including the print information after execution of the one or more specific processes to a preregistered information processing terminal that is to transmit the print request to a printer.

2. The information processing system according to claim 1, wherein the processor is configured to convert the print request to information in a predetermined common format, and transmit the converted information to the information processing terminal.

3. The information processing system according to claim 1, wherein the processor is configured to execute at least one from among a history management process, an authorization process, and a confidentiality process as the one or more specific processes.

4. The information processing system according to claim 1, wherein the processor is configured to display, on the information processing terminal, a progress of transmitting the print request after execution of the one or more specific processes to the information processing terminal.

5. The information processing system according to claim 1, wherein the processor is configured to set a period of validity for the print request and transmit the print request to the information processing terminal.

6. The information processing system according to claim 5, wherein the processor is configured to confirm the period of validity at a predetermined timing, and remove the print request that has expired.

7. The information processing system according to claim 6, wherein the predetermined timing is at least one from among when an application is launched on the information processing terminal, when the application moves from background to foreground, and when a fixed time elapses.

8. The information processing system according to claim 1, wherein the processor is configured to accept a selection result of the information processing terminal to which to transmit the print request after execution of the one or more specific processes, and transmit the print request to the selected information processing terminal.

9. The information processing system according to claim 8, wherein the processor is configured to accept the information processing terminal designated by a user or all information processing terminals carried by the user as the selection result.

10. The information processing system according to claim 1, wherein the processor is configured to transmit the print request that has been transmitted to the information processing terminal to the printer by wireless communication.

11. An information processing method comprising:
accepting a print request including print information to be printed and executing one or more predetermined specific processes on the print information included in the accepted print request; and
transmitting the print request including the print information after execution of the one or more specific processes to a preregistered information processing terminal that is to transmit the print request to a printer.

12. A non-transitory computer readable medium storing a program causing a computer to execute a process comprising:
accepting a print request including print information to be printed and executing one or more predetermined specific processes on the print information included in the accepted print request; and
transmitting the print request including the print information after execution of the one or more specific processes to a preregistered information processing terminal that is to transmit the print request to a printer.
